(19) United States
(12) Patent Application Publication
(10) Pub. No.: US 2025/0261801 A1
(43) Pub. Date: Aug. 21, 2025

(54) SLOW COOKER

(71) Applicant: SHENZHEN YINGBOWEIYE TECHNOLOGY CO., LTD, Shenzhen (CN)

(72) Inventors: Jinghua XIE, Shenzhen (CN); Jingru XIE, Shenzhen (CN); Shanyou CHEN, Shenzhen (CN); Yong CAI, Shenzhen (CN)

(21) Appl. No.: 18/617,957

(22) Filed: Mar. 27, 2024

(30) Foreign Application Priority Data
Feb. 20, 2024 (CN) 202420319328.9

(51) Int. Cl. A47J 43/046; A47J 27/00; A47J 43/08

(52) U.S. Cl. CPC A47J 43/0465; A47J 27/004; A47J 43/085

(57) ABSTRACT

Disclosed is a slow cooker, the slow cooker comprises a shell, an inner container, a heating assembly, a magnetic stirring assembly and a limiting cover; the heating assembly is arranged between the inner container and the shell; the magnetic stirring assembly comprises a driving member, a first magnet and a second magnet, two ends of the driving member are respectively connected with the shell and the first magnet, the second magnet is arranged in an accommodating cavity, and the second magnet and the first magnet are arranged on two opposite sides of the inner container at interval; the limiting cover is connected with the inner container, and the limiting cover is provided with a water outlet hole; and a limiting space is enclosed by the limiting cover and the inner container, and the second magnet is arranged in the limiting space.

### CROSS REFERENCE TO RELATED APPLICATIONS

The present application claims the benefit of Chinese Patent Application No. 202420319328.9 filed on Feb. 20, 2024, the contents of which are incorporated herein by reference in their entirety.

### TECHNICAL FIELD

The present application relates to the technical field of kitchen electrical appliances, and particularly to a slow cooker.

### BACKGROUND

A principle of a slow cooker is to heat food ingredients for a long time at a temperature of 80° C. to 95° C. to slowly release nutrients and taste in food and avoid the loss of taste of the food due to high temperature at the same time. A magnetic stirring device is used in some existing slow cookers to stir a fluid in the cooker through a magneton, thus achieving the uniformity of temperature and solute. However, the magneton is very easy to be mixed with the food due to a small dimension, so that it is very troublesome to distinguish and take out the magneton, and even serious accidents such as eating by mistake of a user may occur. Therefore, it is necessary to design a slow cooker capable of easily screening out the magneton.

### SUMMARY

In order to solve at least one problem in the prior art, the present application provides a slow cooker, and the slow cooker comprises a shell, an inner container, a heating assembly, a magnetic stirring assembly and a limiting cover; a placing cavity is enclosed by the shell; the inner container is arranged in the placing cavity, and an accommodating cavity is enclosed by the inner container; the heating assembly is arranged between the inner container and the shell; the magnetic stirring assembly comprises a driving member, a first magnet and a second magnet, two ends of the driving member are respectively connected with the shell and the first magnet, the second magnet is arranged in the accommodating cavity, and the second magnet and the first magnet are arranged on two opposite sides of the inner container at interval; the limiting cover is connected with the inner container, and the limiting cover is provided with a water outlet hole; and a limiting space is enclosed by the limiting cover and the inner container, the second magnet is arranged in the limiting space, and the limiting space is used for limiting a movement range of the second magnet.

In some embodiments, the inner container comprises a body portion and a limiting portion, the body portion surrounds the limiting portion and the accommodating cavity is enclosed by the body portion and the limiting portion jointly, the limiting portion and the first magnet are arranged at interval, and the first magnet and the second magnet are arranged on two opposite sides of the limiting portion.

In some embodiments, the limiting portion protrudes towards the first magnet to form a first limiting groove, and the limiting cover is inserted into the first limiting groove.

In some embodiments, one of the limiting portion and the limiting cover is provided with a clamping groove, the other of the limiting portion and the limiting cover is provided with a buckle, and the buckle is inserted into the clamping groove.

In some embodiments, the limiting cover comprises a top shell and a side shell, the side shell surrounds the top shell, the side shell is connected with the inner container, the limiting space is enclosed by the top shell, the side shell and the limiting portion jointly, and at least one of the top shell and the side shell is provided with the water outlet hole.

In some embodiments, the water outlet hole comprises a first water outlet hole, a plurality of second water outlet holes and a plurality of third water outlet holes, the first water outlet hole is arranged in a center position of the top shell, the plurality of second water outlet holes and the plurality of third water outlet holes respectively surround the first water outlet hole, and the second water outlet holes are arranged between the first water outlet hole and the third water outlet holes at interval.

In some embodiments, the second water outlet hole is arc-shaped, the third water outlet hole is arc-shaped, and an arc length of the third water outlet hole is larger than that of the second water outlet hole.

In some embodiments, the slow cooker comprises a placing rack arranged in the accommodating cavity; and the placing rack comprises a first rack body and a plurality of second rack bodies, the first rack body forms an annular frame structure, and the plurality of second rack bodies are arranged at interval along a width direction of the annular frame structure.

In some embodiments, the placing rack further comprises third rack bodies connected with the plurality of second rack bodies respectively, the third rack body is connected to a part of the second rack body close to the inner container, and a projection of a region in which the plurality of second rack bodies are connected with the third rack bodies on a bottom surface of the inner container covers a projection of the limiting cover on the bottom surface of the inner container.

In some embodiments, the first rack body comprises a plurality of first portions and a plurality of second portions, the plurality of first portions and the plurality of second portions are alternately arranged to form the annular frame structure, the first portions are away from the inner container relative to the second portions, the first portions are parallel to the second rack bodies, the second portions are connected with the plurality of second rack bodies respectively, and the third rack bodies are further connected with the first portions.

Compared with the prior art, the embodiment of the present application has the beneficial effects that the heating assembly heats and regulates the inner container, and the magnetic stirring assembly drives a fluid in the cooker to be rotatably stirred, thus realizing slow cooking of food at a low temperature. The limiting space enclosed by the limiting cover and the inner container is a movement space of the second magnet, which is beneficial for quickly distinguishing and finding the second magnet, and reducing the difficulty of distinguishing and finding the second magnet, thus avoiding the danger of eating by mistake of a user, and improving the use experience and safety performance of the product.

### BRIEF DESCRIPTION OF THE DRAWINGS

FIG. 1 is an overall schematic diagram of an embodiment provided by the present application;

FIG. 2 is a sectional view of the embodiment shown in FIG. 1;

FIG. 3 is an exploded view of the embodiment shown in FIG. 1;

FIG. 4 is a partially enlarged view of a magnetic stirring assembly in FIG. 1;

FIG. 5 is a partially enlarged view of a limiting cover and an inner container in FIG. 3;

FIG. 6 is a partially enlarged view of a driving member and a first magnet in FIG. 3;

FIG. 7 is a schematic structural view of a placing rack in FIG. 3;

FIG. 8 is a positional relationship diagram of a heating assembly in FIG. 1;

FIG. 9 is a positional relationship diagram of a heating member and a display in FIG. 8; and

FIG. 10 is a schematic diagram of connection between a cooker cover and a shell in FIG. 1.

| Numerals | Name | Numerals | Name |
|---|---|---|---|
| 100 | Slow cooker | 142 | First magnet |
| 110 | Shell | 143 | Second magnet |
| 101 | Placing cavity | 150 | Placing rack |
| 120 | Inner container | 151 | First rack body |
| 102 | Accommodating cavity | 1511 | First portion |
| 122 | Body portion | 1512 | Second portion |
| 123 | Limiting portion | 152 | Second rack body |
| 1231 | First limiting groove | 153 | Third rack body |
| 1232 | Buckle | 160 | Heating assembly |
| 130 | Limiting cover | 161 | Heating member |
| 131 | Top shell | 162 | Sensor |
| 1311 | First water outlet hole | 163 | Display |
| 1312 | Second water outlet hole | 106 | Detection hole |
| 1313 | Third water outlet hole | 170 | Cooker cover |
| 132 | Side shell | 171 | Handle |
| 1321 | Clamping groove | 172 | Observation window |
| 140 | Magnetic stirring assembly | 173 | Housing |
| 141 | Driving member | | |

### DETAILED DESCRIPTION

In order to make those skilled in the art better understand the technical solution of the present application, the present application is described in detail hereinafter with reference to the drawings, and the descriptions in this part are only exemplary and explanatory, and should not limit the scope of protection of the present application.

It should be noted that: similar reference numerals and letters indicate similar items in the following drawings, so once one item is defined in one drawing, it does not need to be further defined and explained in the following drawings.

It should be noted that if the orientation or position relationship indicated by the terms “center”, “upper”, “lower”, “left”, “right”, “vertical”, “horizontal”, “inner”, “outer”, and the like is based on the orientation or position relationship shown in the drawings, or the orientation or position relationship of the product of the present application in use, it is only for the convenience of description of the present application and simplification of the description, and it is not to indicate or imply that the indicated device or element must have a specific orientation, and be constructed and operated in a specific orientation. Therefore, the terms should not be understood as limiting the present application. In addition, the terms “first”, “second”, “third”, and the like are used for distinguishing description only and cannot be understood as indicating or implying relative importance.

In addition, the terms “horizontal”, “vertical”, “overhanging”, and the like do not mean that the components are required to be absolutely horizontal or overhanging, but may be slightly inclined. For example, “horizontal” only means that the direction is more horizontal relative to “vertical”, and does not mean that the structure must be completely horizontal, but may be slightly inclined.

Unless otherwise defined, all technical and scientific terms used herein have the same meanings as those commonly understood by those skilled in the technical field of the present application. The terms used in the specification of the present application herein are only for the purpose of describing specific embodiments, and are not intended to limit the present application.

The present application is further described in detail hereinafter with reference to the drawings.

The present application provides a slow cooker 100, and the slow cooker 100 comprises a shell 110, an inner container 120, a heating assembly 160, a magnetic stirring assembly 140 and a limiting cover 130. A placing cavity 101 is enclosed by the shell 110. The inner container 120 is arranged in the placing cavity 101, and an accommodating cavity 102 is enclosed by the inner container 120. The heating assembly 160 is arranged between the inner container 120 and the shell 110. The magnetic stirring assembly 140 comprises a driving member 141, a first magnet 142 and a second magnet 143, two ends of the driving member 141 are respectively connected with the shell 110 and the first magnet 142, the second magnet 143 is arranged in the accommodating cavity 102, and the second magnet 143 and the first magnet 142 are arranged on two opposite sides of the inner container 120 at interval. The limiting cover 130 is connected with the inner container 120, and the limiting cover 130 is provided with a water outlet hole. A limiting space is enclosed by the limiting cover 130 and the inner container 120, the second magnet 143 is arranged in the limiting space, and the limiting space is used for limiting a movement range of the second magnet 143.

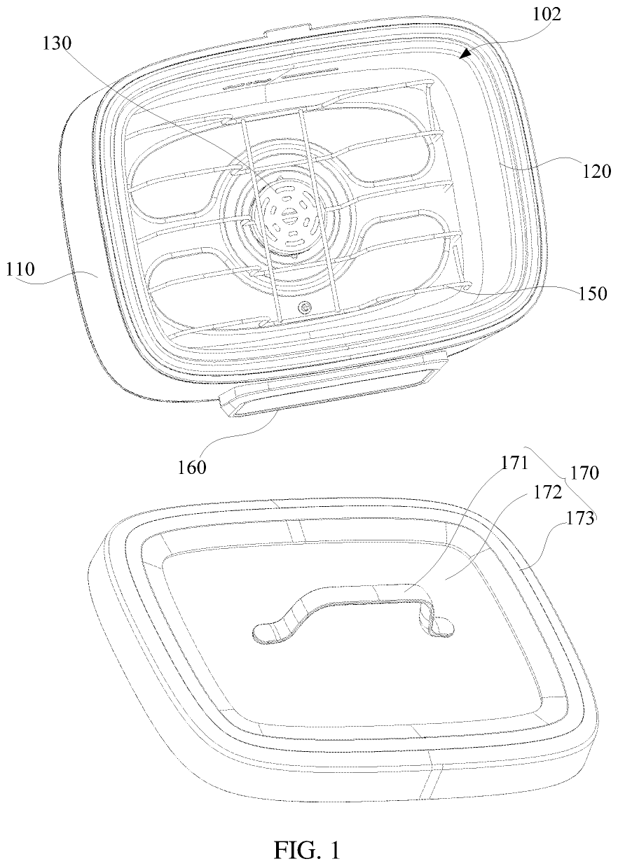

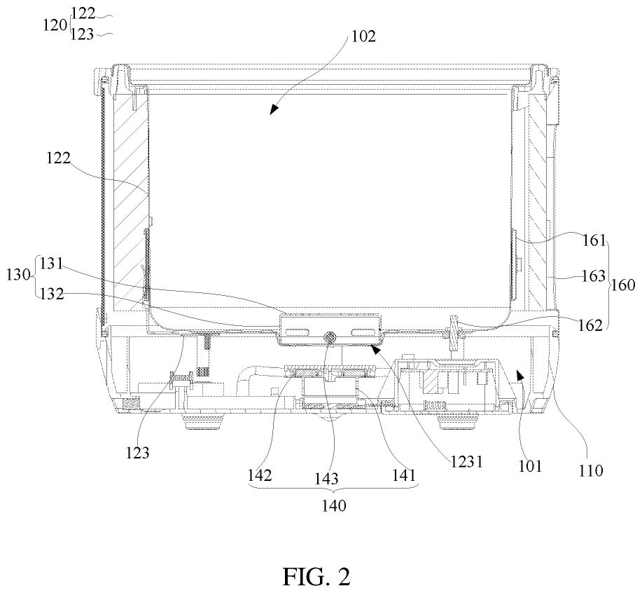

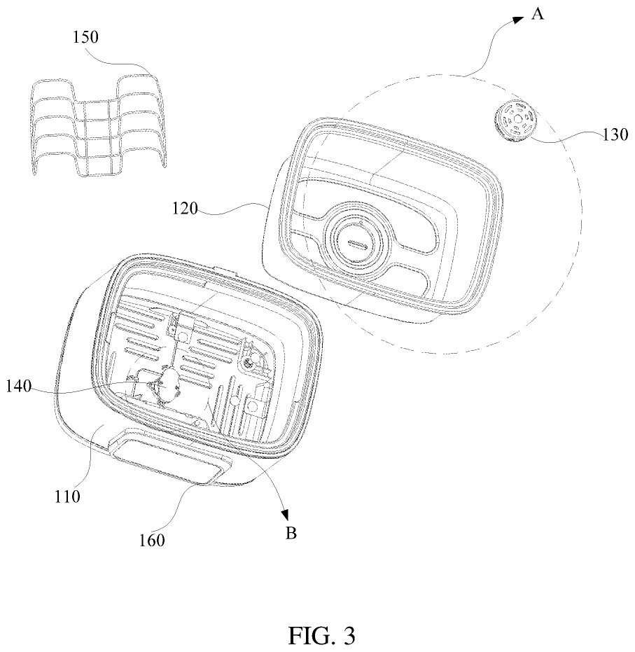

With reference to FIG. 1, FIG. 2 and FIG. 3, the slow cooker 100 provided by the present application is provided with the protective shell 110 on an outermost layer, a lowest end of the shell 110 is used for mounting parts, the placing cavity 101 provides an avoidance space for the parts, and a shape of the placing cavity 101 may be selected from a cylinder, a prism and the like.

The shell 110 is preferably made of plastic and ceramic, which has good heat isolation and insulation performances, a low price and a light weight. The inner container 120 is made of a metal or non-metal material, which is usually stainless steel and ceramic, and a shape of the accommodating cavity 102 enclosed by the inner container 120 is the same as the shape of the placing cavity 101, thus being convenient for fixing and placing the inner container 120. A side wall of the inner container 120 is connected with a side wall of the shell 110, and the inner container 120 and the shell 110 may be designed in an integrated mode (that is, the inner container and the shell cannot be separated) or designed in a separable mode.

The heating assembly 160 heats the inner container 120, slowly cooks food in the inner container 120, and may monitor and control energy output in real time to regulate a temperature in the inner container 120, thus being convenient for a user to cook the food finely.

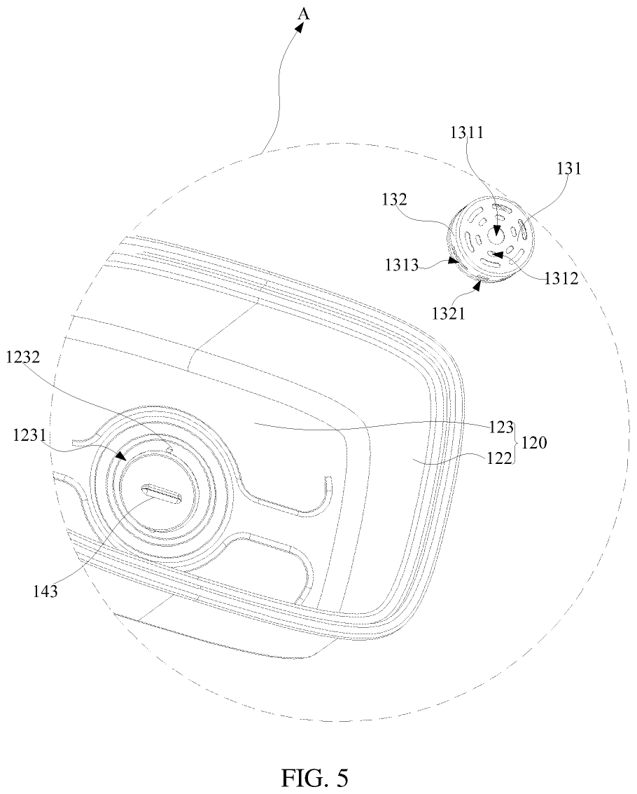

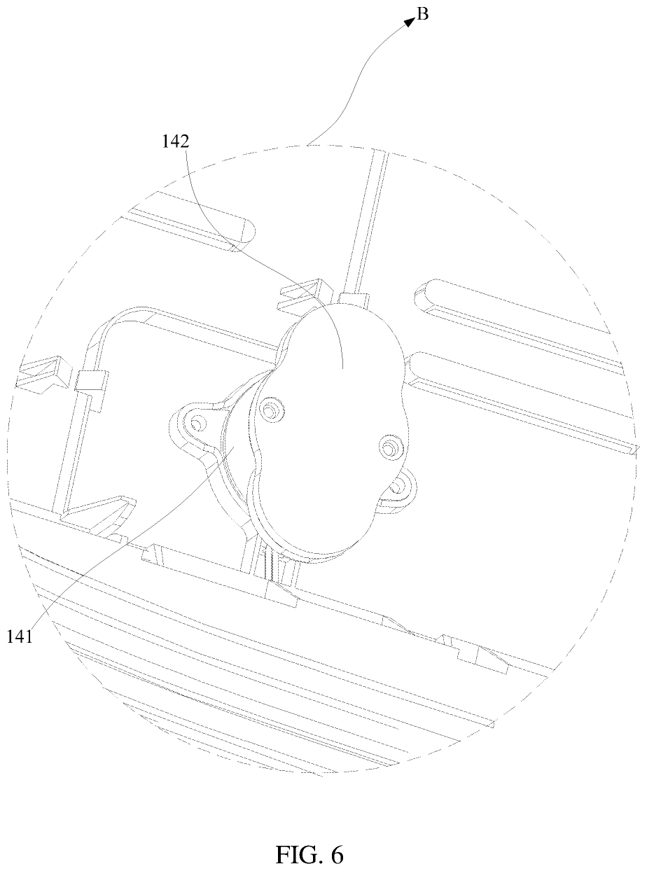

With reference to FIG. 5 and FIG. 6, the magnetic stirring assembly 140 stirs a fluid in the inner container 120 by magnetic stirring to maintain a temperature of the fluid in all parts of the inner container 120 the same, thus avoiding the decrease of a cooking effect caused by uneven heating of the food. A principle of the magnetic stirring assembly 140 is that the driving member 141 drives the first magnet 142 to rotate, a generated rotating magnetic field drives the second magnet 143 to rotate, and the second magnet 143 stirs the fluid in the inner container 120 during the rotation, thus realizing a stirring function.

In this embodiment, the driving member 141 is a motor, and the first magnet 142 and the second magnet 143 are both magnetic iron. The motor drives the first magnet 142 to rotate, and the second magnet 143 rotates accordingly under the magnetic field. It is known that polytetrafluoroethylene (PTFE, commonly known as Teflon) has good heat resistance, and excellent resistance to acid, alkali and organic solvents, and has no side effects on human body, so that in this embodiment, the second magnet 143 is wrapped with a layer of polytetrafluoroethylene, which can not only protect the second magnet 143, but also avoid the second magnet 143 from polluting the food in the cooker. In other embodiments, the driving member 141 may be an electric machine, and the first magnet 142 may be an iron bar wound with a wire, an electromagnetic relay, and the like.

In this embodiment, the driving member 141 is arranged in an axis position of the shell 110, so that the whole magnetic stirring assembly 140 is arranged in the axis position of the shell 110. In other embodiments, the magnetic stirring assembly 140 may be arranged in an edge position of the shell 110.

In order to solve the problem of distinguishing and taking out the second magnet 143, the slow cooker 100 of the present application comprises the limiting cover 130, and the limiting space enclosed by the limiting cover 130 and the inner container 120 limits a position of the second magnet 143, which is convenient for the second magnet 143 to rotate within a predetermined range, thus realizing the stirring function. The limiting cover 130 is provided with the water outlet hole, and the fluid may freely flow into or out of the limiting space. The rotation of the second magnet 143 drives the fluid to rotate, which is beneficial for the distribution of temperature, nutrients and taste throughout the inner container 120. After the slow cooker 100 is used, the second magnet 143 may be taken out for cleaning by opening the limiting cover 130, which is simple and convenient.

Compared with the prior art, the embodiment of the present application has the beneficial effects that the heating assembly 160 heats and regulates the inner container 120, and the magnetic stirring assembly 140 drives the fluid in the cooker to be rotatably stirred, thus realizing slow cooking of food at a low temperature. The limiting space enclosed by the limiting cover 130 and the inner container 120 is a movement space of the second magnet 143, which is beneficial for quickly distinguishing and finding the second magnet 143, and reducing the difficulty of distinguishing and finding the second magnet 143, thus avoiding the danger of eating by mistake of a user, and improving the use experience and safety performance of the product.

In some embodiments, the inner container 120 comprises a body portion 122 and a limiting portion 123, the body portion 122 surrounds the limiting portion 123 and the accommodating cavity 102 is enclosed by the body portion and the limiting portion jointly, the limiting portion 123 and the first magnet 142 are arranged at interval, and the first magnet 142 and the second magnet 143 are arranged on two opposite sides of the limiting portion 123.

With reference to FIG. 2, the body portion 122 is located on the side wall of the inner container 120, and the body portion 122 is used for being connected with the shell 110. The limiting portion 123 is located at a lower portion of the inner container 120, and the limiting portion 123 is used for supporting the body portion 122. The accommodating cavity 102 enclosed by the body portion 122 and the limiting portion 123 is used for accommodating the food.

Obviously, the inner container 120 is arranged vertically, so that the first magnet 142 is arranged below the limiting portion 123, the second magnet 143 is arranged above the limiting portion 123, and the first magnet 142 applies a rotating magnetic moment to the second magnet 143, so that the second magnet 143 rotates, thus stirring the fluid in the accommodating cavity 102.

In some embodiments, the limiting portion 123 protrudes towards the first magnet 142 to form a first limiting groove 1231, and the limiting cover 130 is inserted into the first limiting groove 1231.

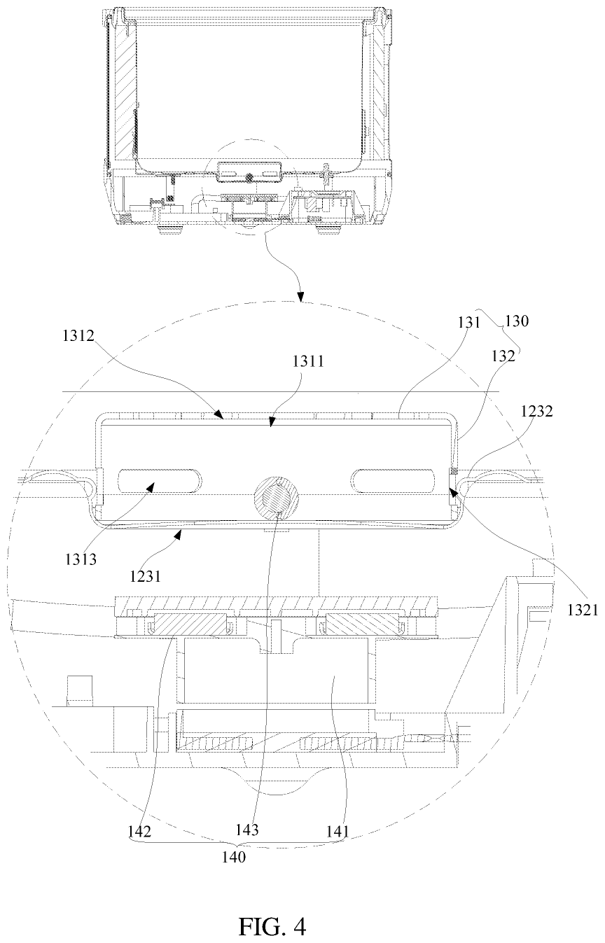

With reference to FIG. 4 and FIG. 5, the limiting cover 130 is inserted into the first limiting groove 1231, and the limiting cover and the first limiting groove firmly limit the movement space of the second magnet 143. In this embodiment, a center of the limiting portion 123 is provided with the circular first limiting groove 1231, and the first limiting groove 1231 may be separately machined, or stamped by a die in the production of the inner container 120.

A shape of the first limiting groove 1231 needs to be consistent with a cross-sectional shape of the limiting cover 130, which is convenient for connecting the limiting cover 130 with the first limiting groove 1231. In other embodiments, according to the cross-sectional shape of the limiting cover 130, the first limiting groove 1231 may be designed as a polygon, an arc, a bow, or the like. If a mounting position of the magnetic stirring assembly 140 is at an edge of the limiting portion, the first limiting groove 1231 may also be correspondingly arranged in an edge position of the limiting portion 123.

In some embodiments, one of the limiting portion 123 and the limiting cover 130 is provided with a clamping groove 1321, the other of the limiting portion 123 and the limiting cover 130 is provided with a buckle 1232, and the buckle 1232 is inserted into the clamping groove 1321.

With reference to FIG. 5, in this embodiment, the limiting cover 130 is provided with the clamping groove 1321, the limiting portion 123 is provided with the buckle 1232, and after the limiting cover 130 is inserted into the first limiting groove 1231, the limiting cover 130 is gently rotated until the buckle 1232 abuts against the clamping groove 1321, that is, the mounting of the limiting cover 130 is completed. The limiting cover 130 is disassembled by reverse steps.

In other embodiments, the buckle 1232 may be arranged on the limiting cover 130, and the clamping groove 1321 may be arranged on the limiting groove.

In some embodiments, the limiting cover 130 comprises a top shell 131 and a side shell 132, the side shell 132 surrounds the top shell 131, the side shell 132 is connected with the inner container 120, the limiting space is enclosed by the top shell 131, the side shell 132 and the limiting portion 123 jointly, and at least one of the top shell 131 and the side shell 132 is provided with the water outlet hole.

With reference to FIG. 5, the limiting cover 130 in this embodiment is a cylinder as a whole, the side shell 132 is located on a side surface of the cylinder, the top shell 131 is located at an upper end of the cylinder, and an edge of the side shell 132 is inserted into the limiting groove during mounting, so that the closed limiting space is formed to limit the movement range of the second magnet 143.

The water outlet hole is located in the limiting cover 130, there are specific embodiments that the top shell 131 is provided with the water outlet hole, the side shell 132 is provided with the water outlet hole, and the top shell 131 and the side shell 132 are both provided with the water outlet holes, and the three embodiments are freely selected. The arrangement of the water outlet hole enables fluids inside and outside the limiting cover 130 to be in contact with each other, which is beneficial for the uniform distribution of energy and substance in the inner container 120.

In other embodiments, the top shell 131 may be designed as a polygon, and a column is enclosed by the side shell 132 and the top shell 131.

In some embodiments, the water outlet hole comprises a first water outlet hole 1311, a plurality of second water outlet holes 1312 and a plurality of third water outlet holes 1313, the first water outlet hole 1311 is arranged in a center position of the top shell 131, the plurality of second water outlet holes 1312 and the plurality of third water outlet holes 1313 respectively surround the first water outlet hole 1311, and the second water outlet holes 1312 are arranged between the first water outlet hole 1311 and the third water outlet holes 1313 at interval.

With reference to FIG. 4 and FIG. 5, specifically, in this embodiment, the first water outlet hole 1311 is arranged in the center position of the top shell 131, and the arrangement of the first water outlet hole 1311 allows the fluids inside and outside the limiting cover 130 to be in full contact. When the second magnet 143 rotates, the fluid near the second magnet 143 rotates accordingly, so as to drive the fluid on a center line of the inner container 120 to rotate, thus accelerating heat conduction and material flow in an axial direction.

In order to further promote the flow in the axial direction, the top shell 131 is provided with the plurality of second water outlet holes 1312 with the first water outlet hole 1311 as a center of circle, and the arrangement of the second water outlet holes 1312 increases paths of energy transmission, which is beneficial for expanding a stirring range.

In order to promote flow in a radial direction, the side wall of the limiting cover 130 is provided with the plurality of third water outlet holes 1313, and in the axial direction, the third water outlet holes 1313 are communicated with the fluid in the axial direction. When the second magnet 143 rotates, energy may spread to the fluid in the axial direction, and the fluid in the axial direction may also rotate, thus promoting the uniform mixing of materials in the axial direction and at the bottom portion of the inner container 120.

In this embodiment, the first water outlet hole 1311 is circular, and the second water outlet hole 1312 and the third water outlet hole 1313 are both arc-shaped. In other embodiments, the first water outlet hole 1311, the second water outlet hole 1312 and the third water outlet hole 1313 may all be circular, and are machined by stamping or punching, which is convenient to machine and has high production efficiency.

In some embodiments, the second water outlet hole 1312 is arc-shaped, the third water outlet hole 1313 is arc-shaped, and an arc length of the third water outlet hole 1313 is larger than that of the second water outlet hole 1312.

Specifically, in this embodiment, a production method of the water outlet hole is to slot while rotating the limiting cover 130, so that the second water outlet hole 1312 and the third water outlet hole 1313 are arc-shaped. Due to a large number of the first water outlet holes 1311 and a large number of the second water outlet holes 1312 on the top shell 131, a flow area of the top shell 131 is large. In order to balance energy distribution in the axial direction and the radial direction, the arc length of the third water outlet hole 1313 is designed to be larger than that of the second water outlet hole 1312, so that a flow area in the axial direction and a flow area in the radial direction of the limiting cover 130 are approximately equal, which is beneficial for the uniform distribution of energy, which means to be beneficial for the full stirring of the second magnet 143.

In other embodiments, the second water outlet hole 1312 and the third water outlet hole 1313 may be set in a triangle or a pentagram, and the limiting cover 130 may also be designed in a mesh structure, which can also achieve the purpose of limiting the second magnet 143 and transmitting energy, which will not be strictly limited herein.

In some embodiments, the slow cooker 100 comprises a placing rack 150 arranged in the accommodating cavity 102; and the placing rack 150 comprises a first rack body 151 and a plurality of second rack bodies 152, the first rack body 151 forms an annular frame structure, and the plurality of second rack bodies 152 are arranged at interval along a width direction of the annular frame structure.

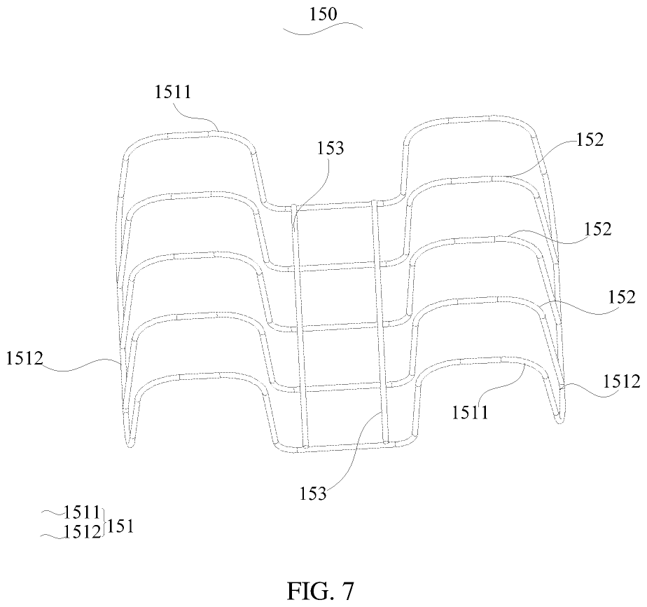

With reference to FIG. 1 and FIG. 7, the slow cooker 100 provided by the present application further comprises the placing rack 150, and the placing rack 150 is usually made of stainless steel and may also be made of ceramic or plastic. The placing rack 150 is placed in the inner container 120, and meat, a seasoning packet, and other packages are arranged on the placing rack 150 for cooking.

The first rack body 151 is arranged at an outermost periphery as a supporting frame of the placing rack 150, the plurality of second rack bodies 152 are arranged at interval in a region enclosed by the first rack body 151, groove structures may be formed between the first rack body 151 and the second rack bodies 152 and between adjacent second rack bodies 152, and packaged food, the seasoning packet and the like are inserted into the groove structures, so that these seasoning packets can be quickly separated from the groove structures after soup cooking is completed.

In this embodiment, three second rack bodies 152 are provided, and in other embodiments, two, four and more second rack bodies 152 may be provided.

In some embodiments, the placing rack 150 further comprises third rack bodies 153 connected with the plurality of second rack bodies 152 respectively, the third rack body 153 is connected to a part of the second rack body 152 close to the inner container 120, and a projection of a region in which the plurality of second rack bodies 152 are connected with the third rack bodies 153 on a bottom surface of the inner container 120 covers a projection of the limiting cover 130 on the bottom surface of the inner container 120.

With reference to FIG. 7, further, in order to enhance the firmness of connection between the first rack body 151 and the second rack bodies 152 in a front-back direction, the first rack body 151 and middle portions of the second rack bodies 152 are connected with two third rack bodies 153 in this embodiment by connection methods comprising, but being not limited to, integral molding, sliding connection, buckle connection and embedded connection. The arrangement of the third rack bodies 153 has the functions of fixing positions of the first rack body 151 and the middle portions of the second rack bodies 152, preventing deformation and supporting a food ingredient packet, which is beneficial for the overall stability of the placing rack 150 and is also convenient for the food ingredient packet to be easily and quickly arranged on the placing rack 150.

A middle region in FIG. 7 is a connection region between the second rack bodies 152 and the third rack bodies 153, and an area of the region is larger than a cross-sectional area of the limiting cover 130, so that an area of the projection of this part on the inner container 120 is larger than an area of the projection of the limiting cover 130 on the inner container 120. The advantage of this design is to avoid edge parts of the second rack body 152 and the third rack body 153 from colliding and jamming with the limiting cover 130, and use the limiting cover 130 as a fulcrum to support the placing rack 150 at the same time, thus improving the mounting convenience and mounting stability of the placing rack 150.

In other embodiments, three, four and more third rack bodies 153 may be provided; and one, two, three and more third rack bodies 153 may be arranged at convex parts of the second rack bodies 152. In addition, the convex parts and concave parts of the second rack bodies 152 are only relative. When the placing rack 150 in FIG. 7 is upside down, the placing rack may also be placed into the inner container 120 for use. At this time, a middle part is the convex part and two sides are the concave parts, so that it is not necessary to make a strict distinction between the convex part and the concave part.

In some embodiments, the first rack body 151 comprises a plurality of first portions 1511 and a plurality of second portions 1512, the plurality of first portions 1511 and the plurality of second portions 1512 are alternately arranged to form the annular frame structure, the first portions 1511 are away from the inner container 120 relative to the second portions 1512, the first portions 1511 are parallel to the second rack bodies 152, the second portions 1512 are connected with the plurality of second rack bodies 152 respectively, and the third rack bodies 153 are further connected with the first portions 1511.

With reference to FIG. 7, further, in this embodiment, an annular frame is enclosed by the first rack body 151, so that two first portions 1511 and two second portions 1512 are provided. In other embodiments, when the placing rack 150 is designed as a polygon, three, four and more first portions 1511 and three, four and more second portions 1512 are provided, a closed frame is enclosed by the first portions 1511 and the second portions 1512 jointly to serve as a supporting and connecting site for the second rack body 152 and the third rack body 153, which provides support for the food ingredient packet at the same time.

In this embodiment, the first portion 1511 is in a wave shape, the second portion 1512 is in a straight line, and the groove structure is enclosed by the first portion 1511 and the second rack body 152 to serve as the frame of the placing rack 150. The second portion 1512 fixes the second rack body 152 in a left-right direction. Similarly, the second rack body 152 and the second portion 1512 are connected by connection methods comprising, but being not limited to, integral molding, sliding connection, buckle connection and embedded connection.

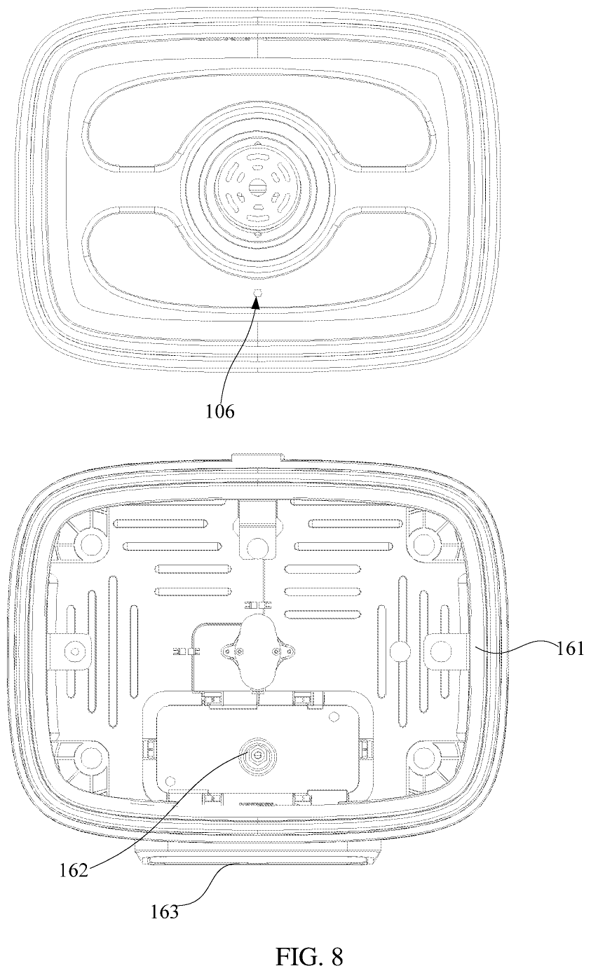

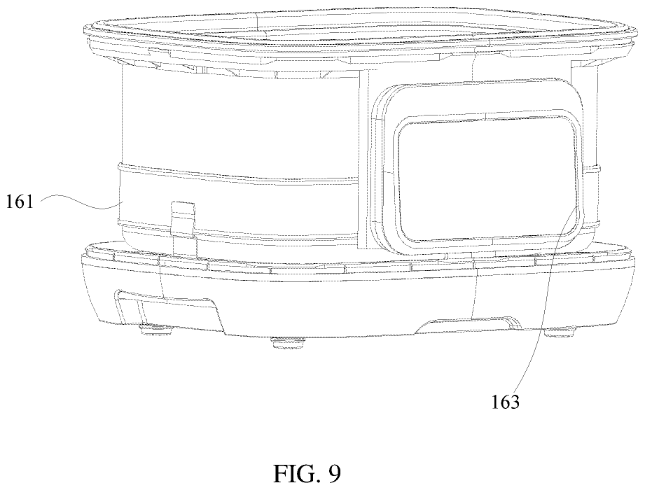

In addition, as a supplementary and expanded solution, the heating assembly 160 of the slow cooker 100 provided by the present application comprises a sensor 162, a heating member 161 and a display 163. With reference to FIG. 8 and FIG. 9, the heating member 161 surrounds the outside of the inner container 120, the inner container 120 is provided with a detection hole 106, the sensor 162 penetrates through the inner container 120, and the display 163 is arranged on an outer side of the shell 110. The display 163 monitors and adjusts a heating condition and regulates a rotating state of the magnetic stirring assembly 140, thus realizing uniform slow cooking.

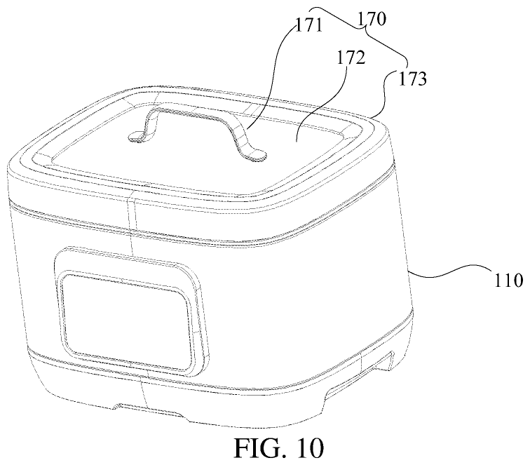

With reference to FIG. 10, the slow cooker 100 provided by the present application further comprises a cooker cover 170, a housing 173 of the cooker cover 170 is made of plastic or metal, the cooker cover 170 is provided with a handle 171 and an observation window 172, and the user covers the cooker cover 170 above the inner container 120 or removes the cooker cover from the inner container 120 through the handle 171. The arrangement of the observation window 172 is beneficial for the user to observe a cooking state of food, so as to adopt appropriate cooking techniques in time.

In the description of the present application, it should also be noted that the terms “arrangement”, “installation”, “connected” and “connection” should be understood in a broad sense unless otherwise clearly specified and defined. For example, they may be fixed connection, removable connection or integrated connection; may be mechanical connection or electrical connection; and may be direct connection indirect connection through an intermediate medium, and connection inside two elements. The specific meanings of the above terms in the present application may be understood in a specific case by those of ordinary skills in the art.

It should be noted that relational terms herein, such as first, second, and the like, are used merely to distinguish one entity or operation from another entity or operation, and do not necessarily require or imply that there is any such relationship or order between these entities or operations. Furthermore, the terms “comprise”, “include”, or any other variation thereof, are intended to cover a non-exclusive inclusion, so that a process, a method, an article, or equipment that comprises a list of elements not only includes those elements but also includes other elements not expressly listed, or further includes elements inherent to such process, method, article, or equipment. In a case without further limitations, an element defined by the phrase “comprising one . . . ” does not preclude the presence of additional identical elements in the process, method, article, or equipment that includes the element.

Although the embodiments of the present application have been shown and described, it is understood by those skilled in the art that various changes, modifications, substitutions and variations may be made to these embodiments without departing from the principle and spirit of the present application, and the scope of the present application is defined by the appended claims and their equivalents.

What is claimed is:

1. A slow cooker (100), wherein the slow cooker (100) comprises:
a shell (110), wherein a placing cavity (101) is enclosed by the shell (110);
an inner container (120), wherein the inner container (120) is arranged in the placing cavity (101), and an accommodating cavity (102) is enclosed by the inner container (120);
a heating assembly (160), wherein the heating assembly (160) is arranged between the inner container (120) and the shell (110);
a magnetic stirring assembly (140), wherein the magnetic stirring assembly (140) comprises a driving member (141), a first magnet (142) and a second magnet (143), two ends of the driving member (141) are respectively connected with the shell (110) and the first magnet (142), the second magnet (143) is arranged in the accommodating cavity (102), and the second magnet (143) and the first magnet (142) are arranged on two opposite sides of the inner container (120) at interval; and
a limiting cover (130), wherein the limiting cover (130) is connected with the inner container (120), and the limiting cover (130) is provided with a water outlet hole;
wherein, a limiting space is enclosed by the limiting cover (130) and the inner container (120), the second magnet (143) is arranged in the limiting space, and the limiting space is used for limiting a movement range of the second magnet (143).

2. The slow cooker (100) according to claim 1, wherein the inner container (120) comprises a body portion (122) and a limiting portion (123), the body portion (122) surrounds the limiting portion (123) and the accommodating cavity (102) is enclosed by the body portion and the limiting portion jointly, the limiting portion (123) and the first magnet (142) are arranged at interval, and the first magnet (142) and the second magnet (143) are arranged on two opposite sides of the limiting portion (123).

3. The slow cooker (100) according to claim 2, wherein the limiting portion (123) protrudes towards the first magnet (142) to form a first limiting groove (1231), and the limiting cover (130) is inserted into the first limiting groove (1231).

4. The slow cooker (100) according to claim 3, wherein one of the limiting portion (123) and the limiting cover (130) is provided with a clamping groove (1321), the other of the limiting portion (123) and the limiting cover (130) is provided with a buckle (1232), and the buckle (1232) is inserted into the clamping groove (1321).

5. The slow cooker (100) according to claim 2, wherein the limiting cover (130) comprises a top shell (131) and a side shell (132), the side shell (132) surrounds the top shell (131), the side shell (132) is connected with the inner container (120), the limiting space is enclosed by the top shell (131), the side shell (132) and the limiting portion (123) jointly, and at least one of the top shell (131) and the side shell (132) is provided with the water outlet hole.

6. The slow cooker (100) according to claim 5, wherein the water outlet hole comprises a first water outlet hole (1311), a plurality of second water outlet holes (1312) and a plurality of third water outlet holes (1313), the first water outlet hole (1311) is arranged in a center position of the top shell (131), the plurality of second water outlet holes (1312) and the plurality of third water outlet holes (1313) respectively surround the first water outlet hole (1311), and the second water outlet holes (1312) are arranged between the first water outlet hole (1311) and the third water outlet holes (1313) at interval.

7. The slow cooker (100) according to claim 6, wherein the second water outlet hole (1312) is arc-shaped, the third water outlet hole (1313) is arc-shaped, and an arc length of the third water outlet hole (1313) is larger than that of the second water outlet hole (1312).

8. The slow cooker (100) according to claim 1, wherein the slow cooker (100) comprises a placing rack (150) arranged in the accommodating cavity (102); and
the placing rack (150) comprises a first rack body (151) and a plurality of second rack bodies (152), the first rack body (151) forms an annular frame structure, and the plurality of second rack bodies (152) are arranged at interval along a width direction of the annular frame structure.

9. The slow cooker (100) according to claim 8, wherein the placing rack (150) further comprises third rack bodies (153) connected with the plurality of second rack bodies (152) respectively, the third rack body (153) is connected to a part of the second rack body (152) close to the inner container (120), and a projection of a region in which the plurality of second rack bodies (152) are connected with the third rack bodies (153) on a bottom surface of the inner container (120) covers a projection of the limiting cover (130) on the bottom surface of the inner container (120).

10. The slow cooker (100) according to claim 9, wherein the first rack body (151) comprises a plurality of first portions (1511) and a plurality of second portions (1512), the plurality of first portions (1511) and the plurality of second portions (1512) are alternately arranged to form the annular frame structure, the first portions (1511) are away from the inner container (120) relative to the second portions (1512), the first portions (1511) are parallel to the second rack bodies (152), the second portions (1512) are connected with the plurality of second rack bodies (152) respectively, and the third rack bodies (153) are further connected with the first portions (1511).
